(19) United States
(12) Patent Application Publication
(10) Pub. No.: US 2013/0164724 A1
(43) Pub. Date: Jun. 27, 2013

(54) SYSTEM AND METHOD FOR IMPLEMENTING MEDICAL PRESCRIPTIONS FACILITATING THE ACCURATE PREPARATION AND USE THEREOF

(71) Applicants: Stuart Allan Rostant, Miami, FL (US); James Stanley Barrett, Orlando, FL (US)

(72) Inventors: Stuart Allan Rostant, Miami, FL (US); James Stanley Barrett, Orlando, FL (US)

(21) Appl. No.: 13/333,399

(22) Filed: Dec. 21, 2011

(51) Int. Cl. G09B 23/28

(52) U.S. Cl. 434/262

(57) ABSTRACT

A system and method for implementing medical prescriptions in a manner which is at least partially independent describing or otherwise representing a medical prescription independent of the writing or other written format originated by a physician, pharmacist, etc. A plurality of indicators are provided, preferably on an indicator composite wherein each of the indicators include indicia representative of the possible terms of a plurality of different prescriptions. At least some of the indicia are pictorial representations wherein selected ones of the plurality of indicators are disposed preferably on any of a plurality of different types of presentation structures in a predetermined array. The indicia of predetermined array of the selected indicators thereby collectively define the operative terms of the prescription which determine accurate and intended content, preparation and terms of use.

### BACKGROUND OF THE INVENTION

1. Field of the Invention

This invention is directed to a system and method for implementing medical prescriptions which is independent and at least partially devoid of a written description or written format. In order to avoid potential inaccuracies in the prepared prescription, a plurality of indicia bearing indicators are utilized to represent the terms or components of medical prescriptions, wherein predetermined ones of the plurality of indicators are selected and arranged in a predetermined array. The predetermined array includes a successive presentation of the indicia on the selected indicators which collectively define the operative terms or components of a prescription intended for a specific patient, thus allowing communications via pictures rather than words and also overcoming any confusion due to language barriers.

2. Description of the Related Art

Unfortunately, there are numerous instances in which prescription medication is misused with harmful and often fatal results. Misuse may involve a variety of different factors, such as taking the correct medication in an improper manner, at an incorrect time schedule and/or at an incorrect time with respect to meals, as well as taking the incorrect medication resulting from similarities between the shape, size, name and/or color of different medication and the bottles or containers in which different medications are dispensed.

Medication misuse often involves people, e.g. elderly people, who have difficulty reading and/or understanding the directions for using a particular medication. For example, it is know that Cardizem CD.™, a prescription medication for blood pressure control, must be swallowed whole in order to be effective. This fact is indicated on the label that accompanies dispensation of the medication. However, elderly people may experience problems swallowing a large capsule and therefore might resort to breaking the capsule into smaller parts or chewing the capsule. This negates the pharmacological effects of the medication so that even though the patient is taking the medication, the desired control of the blood pressure is not being obtained in view of the misuse of the medication.

In the U.S., almost as much money is spent addressing the complications caused by home medication errors as is spent purchasing all the medications dispensed. Three years ago, almost $76 billion a year was spent purchasing medications in the U.S. while another $76 billion was spent treating medication errors including, but not limited to, errors caused by complications experienced by individuals as a result of misunderstandings in taking their medications. The cost of home medication increases ($180 billion+) when the costs to an employer for absenteeism, on-the-job injuries, etc. are included. Home medication errors are a national public health issue that is harming patients and the health care system, as well as the productivity of the U.S.

When a person is non-adherent, i.e., does not follow the proper instructions for taking medication, the cost of the treatment increases for both the consumer and the health care insurance provider. The wise use of prescription drugs can save lives. Prescription drugs should not be causing such high rates of medical complications and deaths as a result of people not being adequately informed. Home medication errors made by patients are linked to hundreds of thousands of deaths a year and cost this country nearly $180 billion in extra medical treatments.

In an attempt to avoid such misuse, accurate and detailed information is typically provided on labels affixed by a pharmacist to containers of prescription medication specifying the exact manner in which the prescription medication should be used.

Each pharmacy typically has its own label design that may be tailored to its specific needs as well as designed to be in compliance with any regulatory or statutory requirements. The label provides the prescription user with instructions and other necessary information to avoid misunderstandings that could lead to misuse of the medication. The information typically contained on the label includes the name, address and telephone number of the pharmacy, the prescription number, a date on which the prescription is prepared, an expiration date of the prescribed medication, the patient's name and address, the dosage and time schedule (e.g., 2 tablets every four hours), the prescribing doctor's name, the number of permissible refills, if any, the name of the medication, the number of capsules or tablets in the bottle, the weight of each capsule or tablet and indications as to whether the medication should be taken with meals, before meals, after meals, with liquids, not in combination with certain products, refrigerated, and the like.

There is no specific order in which the information provided on the label must be displayed. As such, each pharmacy's label is different. This causes inconveniences when one person has multiple prescriptions, each filled at a different pharmacy. Although the patient might be familiar with a label from one pharmacy and know where to look on that label to find information about taking the medication, he or she would have to search for the same information on a label form a different pharmacy.

In addition, when generating forms for prescription labels, pharmacies often do not prioritize the information, i.e., create an order in which the information is to be printed, for example, based on relevancy.

Thus, in a significant number of current prescription labels, there is no hierarchy of importance of the information contained thereon. Rather, it is often the case that the information about the pharmacy, including its logo, if any, is the most prominently displayed information.

Another inconvenience for patients taking medication relates to warning stickers which are applied to the containers at the pharmacy. Such warning stickers generally have standard form and some warning stickers are bright orange or red which black printing. When placed on the containers, it is difficult to read the warnings since the black type does not stand out against the bright colors of the warning stickers, i.e., there is not sufficient contrast. Moreover, the red and orange warning stickers do not stand out against amber containers which are used in some pharmacies.

Another possible inconvenience arises when the stickers are affixed to the container and inadvertently cover up a significant amount of text on the label. This creates a problem for patients to read the information printed on the labels. In addition, the warning sticker also becomes difficult to read.

From the warning stickers to the placement of text on the labels to the size of the type used on the labels, there is no consistency in the labeling of prescriptions. As such, important information regarding the use of a medication is often overlooked since there is no indication that such information is important or even critical to the use of the medication. It would therefore be advantageous to provide a prescription labeling system in which information is placed in the order of importance so that important information is placed before information of lesser importance and is therefore not susceptible to being overlooked.

Another problem with prior medication systems is that the medication containers are usually cylindrical in shape such that the label is wrapped around the entire bottle. In this manner, the information written or printed on the label is often difficult to read since, in order to read all of the information, the bottle must be held and rotated. It would be advantageous if the information appearing on the medicine container, especially relating to the prescription, is presented by indicia in the form of clear, easily understood pictorial representations. This would eliminate or significantly reduce any difficulty associated with interpreting the terms of the prescription appearing on the label or medicine container.

After dispensing the proper medication, most pharmacies place the filled container in a paper bag with printed information about the prescription, as well as additional information such as the price. The bag also may include information about the fastest way to refill the medication. The customer receipt and the prescription information page are attached to the bag. The prescription information page is often a sheet of paper with instructional information printed on both sides. Typically the text is small and information provided is extensive. As a result, the prescription information page is thus often disregarded in view of the sheer amount of text thereon and the difficulty in reading the small print.

Accordingly, in order to overcome the problems and disadvantages associated with a patient discarding or ignoring the prescription page, a feature of the proposed invention would be the inclusion of a separate informative sheet. As such the informative sheet would comprise an explanatory legend representing the meaning of the indicators, indicia, etc. of an improved system and method for implementing medical prescriptions in an accurate and reliable manner.

### SUMMARY OF THE INVENTION

The present invention is directed to a system and method for implementing medical prescriptions in a manner which is independent and at least partially devoid of a written format. As used herein, the term “written format” indicates the specific terms of the prescription being represented in handwritten form, such as when it is written on a prescription pad or the like. By virtue of the various operative and structural features of the system and method of the present invention inaccuracies in the preparation and/or use of the prescribed ingredients are eliminated or significantly reduced. More specifically, the system and method of the present invention avoids the initial presentation or origination by a physician or other medical personnel in the “written format”. Instead, the terms and/or components of the medical prescription, as related to directions, mode, use, time to administer, etc., are clearly and accurately presented by the selected indicators and their corresponding indicia rather than the conventional written format. As an additional benefit, confusion as to the understanding of the terms of a medical prescription would be significantly reduced, wherein the patient was not fluent or sufficiently well versed in the language in which the prescription was written.

Accordingly, the present invention comprises a plurality of indicators each of which includes indicia thereon. The indicia on each of the plurality of indicators is at least partially representative of one or more terms or conditions related to the preparation of the prescribed medication by pharmacist or its use by a patient. As used herein, the term “indicia” is intended to be interpreted in a non-limiting sense as being representative or indicative of one or more terms of a given prescription, wherein a possible majority of the indicia may comprise primarily pictorial representations. However, as will be evident from a more detailed description provided hereinafter, the indicia on at least some of the plurality of indicators may be one or a combination of alpha-numeric characters.

The present invention also includes the utilization of at least one “presentation structure” which may take a variety of different forms such as, but not limited to a prescription form utilized by a physician and on which the details of a specific prescription are displayed. As will also be described in greater detail, the presentation structure defined by a prescription form may be delivered to a pharmacist for the preparation of the prescribed medication either by hand, mail, or other conventional methods of delivery. In addition, the “presentation structure” may be defined as the exterior surface or other appropriate portion of a container in which the prescribed medication stored or presented to a patient. As such, the “presentation structure” may include a label containing the selected indicators, wherein the indicia thereof collectively define the terms of use and/or content. Also, the presentation structure may comprise an existing in-house labeling structure currently in use.

Accordingly, as generally set forth above, the presentation structure can be defined by a hard copy, wherein the plurality of indicators are secured to an exposed face thereof. In addition, the plurality of indicators may include a connector, such as an adhesive backing or the like. In such an additional embodiment the preselected array of indicators which serve to define the terms, components, and/or details of a given, predetermined prescription may be assembled by the removal of selective ones of the indicators from a collection of the plurality of indicators or an “indicator composite”. Once determined, the selected indicators can be placed onto the prescription form by the medical personnel.

Similarly, once the prescription form or other physical, hardcopy of the presentation structure is delivered to the pharmacist, the pharmacist may also remove the plurality of preselected indicators having indicia which defines the terms or components of the indicated prescription and place them on the exterior or exposed surface of the container for the medication defined by the predetermined prescription. In the alternative, a pharmacist may also have access to a separate indicator composite. As such, a label to be placed on the outer surface of the container and or the outer surface itself may be prepared by removing the selected indicators maintained by the pharmacist and placing them directly on the label and/or the outer surface of the medication container. This may also be accomplished by including the selected indicators onto an existing label format and placing the entire label on the medicine container.

Yet another preferred embodiment of the system and method of the present invention includes the use of processor facilities and electronic communication, wherein the one or more processors have adequate storage facilities, as well as an electronic display. A processor may be located at each of a plurality of offices of a medical professional as well as the plurality of offices of different pharmacies located remote from the medical office. When so utilized, this additional preferred embodiment contemplates a software application or program which allows both the medical professional and the pharmacist to display the indicator composite on the display screen of the processor. The “prescription software” thereafter allows the physician or other medical professional to select predetermined ones of the plurality of indicators having indicia which define the terms, components and/or details of a specific prescription.

As with the “hard copy’ embodiment set forth above, once determined, the selected indicators are arranged in a predetermined array of successively displayed indicia and electronically transferred to the processor of an indicated pharmacy. At the receiving pharmacy, the prescription is electronically displayed on the local processor by a visual presentation of the selected indicators. It is emphasized that the predetermined array is defined by a successive or sequential presentation of the indicia on the selected indicators which are representative of the terms, components and details of the prescription originated by the physician or medical professional. The pharmacist thereafter will prepare the label and/or container for the medication so as to provide a display of the terms, components and details of the indicated prescription utilizing the successive presentation of the indicia of the selected indicators.

Accordingly, the system and method of the present invention provides an effective means of implementing medical prescriptions at least partially independent of a handwritten presentation or “written format” thereby avoiding or significantly reducing inaccuracies due to a misinterpretation by the pharmacist and/or patient, thus allowing communication by pictures instead of words.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of a prescription form incorporating the features of the present invention and being of the type which is prepared by the physician and deliverable to a pharmacist.

FIG. 2 is another embodiment of a prescription label incorporating the features of the present invention, similar to the embodiment of FIG. 1.

FIG. 3 is a schematic representation of various steps of the intended method and features of the system of the present invention facilitating the implementation of a specific, predetermined prescription.

FIG. 4 is a schematic representation similar to but distinguishable from the embodiment of FIG. 3.

FIG. 5 is a composite view of a plurality of indicators each of which include indicia thereon which facilitate implementation of medical prescriptions in accord with the system and method of the present invention.

FIG. 6 is a schematic representation of one preferred embodiment of an indicator composite which may be utilized as an option in combination with a presentation structure for implementing different medical prescriptions in accord with the system and method of the present invention.

FIG. 7 is a schematic representation in block diagram form of the system and method of the present invention for implementing medical prescriptions in terms of their origination, preparation and use of at least one predetermined prescription for a specific patient.

FIGS. 8A and 8B are schematic representations of medicine containers and implementation of a predetermined prescription in accord with the system and method of the present invention. Like reference numerals refer to like parts throughout the several views of the drawings.

### DETAILED DESCRIPTION OF THE PREFERRED EMBODIMENT

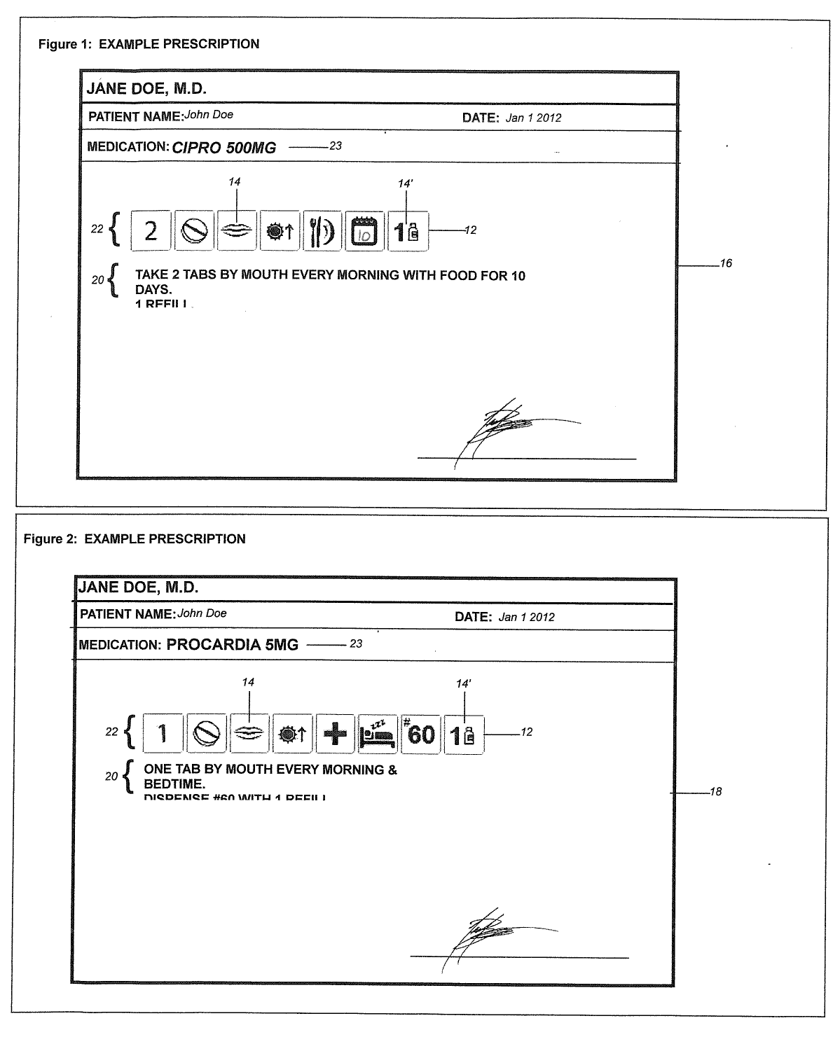

As represented in the accompanying Figures and with initial reference to FIGS. 1 through 5, the present invention is directed to a system for implementing medical prescriptions at least partially independent of a written format. As used herein, the term “written format” is meant to include conventional method of handwritten terms, components and/or details of the prescription such as on a prescription form, as is conventionally and commonly practiced when preparing a prescription for a patient. As set forth herein the origination of a specific, predetermined prescription may be presented by a physician or other medical personnel in “shorthand” or other more conventional handwritten format. In either case, the handwriting of the physician may be difficult to understand because of it not being legible. As a result, inaccuracies in the interpretation of the details of the prescription are all too common.

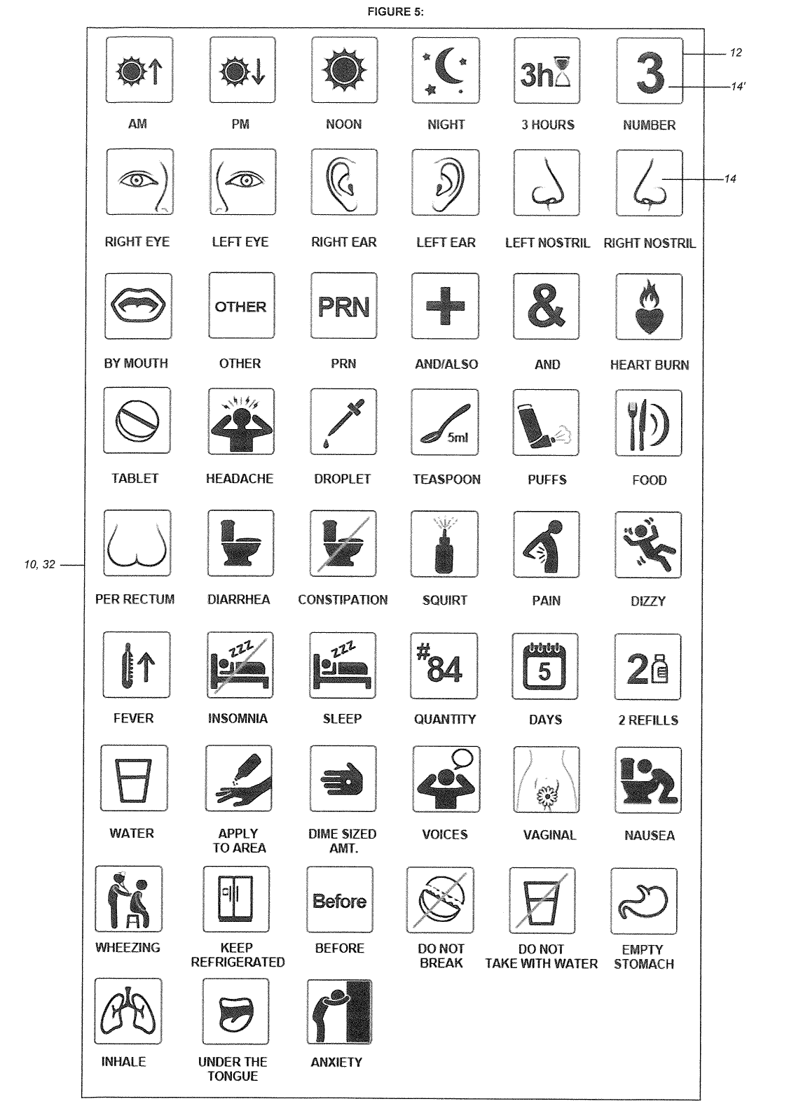

Accordingly, the system and method of the present invention implements each predetermined medical prescription originating with a physician or medical professional in a manner which incorporates a plurality of indicators collectively indicated as 10 in FIG. 5. In addition, each of the plurality of indicators 10 are individually indicated as 12 and include predetermined indicia 14 formed on an exposed, viewable face or surface thereof. With further reference to FIG. 5, at least some or the majority of each of the indicators 12 include indicia 14 being in a pictorial form. However, at least some of the plurality of indicators 12 include one or more alpha/numeric characters, as at 14′. Such alpha-numeric characters may be used independently of other pictorial indicia or in combination therewith as also clearly represented in FIG. 5.

As represented in FIGS. 1 and 2 the system and method of the present invention includes at least one, but preferably a plurality of different “presentation structures”. FIGS. 1 and 2 both represent at least one preferred embodiment of the present invention, wherein the presentation structure is represented by the prescription forms 16 and 18. Accordingly, the one or more presentation structures 16 and/or 18 include the terms, components and details of a given, predetermined prescription intended for a specific patient and generally indicated as 20. The predetermined prescription 20 is therefore represented by a number of selected indicators 12 collectively indicated as 22. As should be apparent the selected indicators 22 are determined by the medical personnel and transferred, using a variety of different techniques, from a larger selection of the plurality of indicators 12 of the indicator composite of the type represented at least in FIG. 5 or 8, the latter being discussed in greater detail herein after.

More specifically, the plurality of selected indicators 22 were chosen by the medical personnel, based on the indicia 14 and 14′ presented thereon. The represented indicia 14, 14′ will be placed or positioned on each of the presentation structures 16 or 18 in a predetermined array as indicated. The predetermined array of the plurality of the selected indicators 22, representative of a given prescription 20, is oriented so as to successively or sequentially present the indicia 14 and 14′, so that the terms, components and/or details of a given prescription are interpreted accurately.

By way of example only FIG. 1 represents a prescription 20 originating from a physician or medical professional which comprises the terms, components and details including: “two tabs by mouth every morning with food for ten days—one refill”. The system and method of the present invention correspondingly represents the original prescription 20 as the plurality of selected indicators 22 or more specifically the indicia 14 and 14′ thereon as arranged in a successive presentation. Therefore, an accurate interpretation of terms, components and details of the specific prescription can be presented in a more accurate, reliable manner by the indicia 14 and 14′ on the predetermined array 22 of selected indicators 12. It should be noted that the prescribed composition or medicine may be separately indicated at 23. Also, the handwritten presentation 20 of the specific prescription is provided in both FIGS. 1 and 2 for purposes of clarity. In actual practice, the handwritten presentation 20 may or may not be included.

An additional example of a specific prescription is represented in FIG. 2, wherein the prescription originating from the physician or medical professional is also indicated as 20 in a written format. That prescription comprises: “One tab by mouth every morning and night daily—sixty tabs are to be dispensed—and I refill is permitted”. In accord with the system and method of the present invention the specific prescription is accurately presented by the indicia 14 and 14′ collectively appearing on the plurality of selected indicators 22. As with FIG. 1, the selected indicators 22 are presented on the presentation structure 18, in the form of a prescription form, in a predetermined, successive array. As such, the original prescription will be indicated by the indicia 14 and 14′ as presented.

It is again noted that because of the reliability and accuracy of the system and method of the present invention the specific prescription provided on each of the presentation structures or prescription labels 16 and 18 may be completely absent the written format 20. Accordingly, while in actual practice the written format 20 may be included on the presentation structure 18 to facilitate increased accuracy, it is herein provided by way of example only in demonstrating the system and method of implementing a prescription in accord with the present invention.

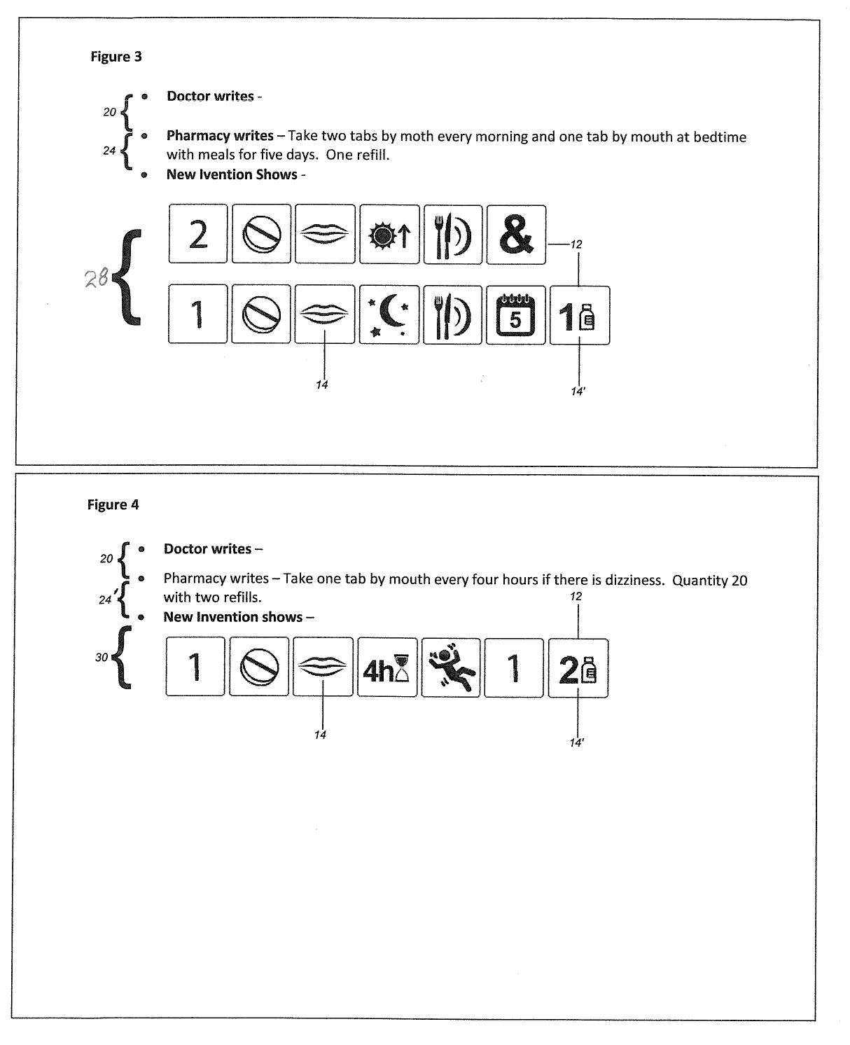

FIGS. 3 and 4 are directed to the attendant method of use for implementing a medical prescription. More specifically, the doctor may originally provide a specific prescription for a given patient in a written format generally indicated as 20, as set forth above. The prescription may then be communicated in such written format 20 directly to the pharmacist. Once the original prescription is reviewed, as represented in FIGS. 3 and 4, the pharmacist interprets the terms, components and/or details of the specific prescription as including: “two tabs by mouth every morning and one tab at bedtime with meals for five days—one refill.” as generally indicated as 24 in FIG. 3. The pharmacist then selects appropriate ones of the plurality of indicators, collectively indicated as 28, and arranges the selected indicators 12 in a predetermined, successive array. As such, the indicia 14 and 14′ on the array 28 of the indicators 12 successively presented as indicated to inform the patient or other individual of the precise terms, components and details of the prescription 20.

Similarly, in FIG. 4 written format 20 may be presented by the physician or other medical professionals and interpreted by the pharmacist as at 24′. Accordingly, the original prescription 20 is presented by the selection of predetermined ones 12 of the plurality of indicators 10, having indicia 14 and 14′ which collectively define the prescription 20, once the selected indicators 12 are arranged in a predetermined successive array 30 such that the indicia 14 and 14′ may be successively presented and interpreted. As with the embodiments of FIGS. 1 and 2 the exemplary embodiments of FIGS. 3 and 4 may or may not be used specifically with the originating prescription 20 presented in a written format. Accordingly, the system and method of the present invention implements any of a plurality of medical prescriptions devoid of or at least not dependent on the originating prescription 20 being represented in a written format.

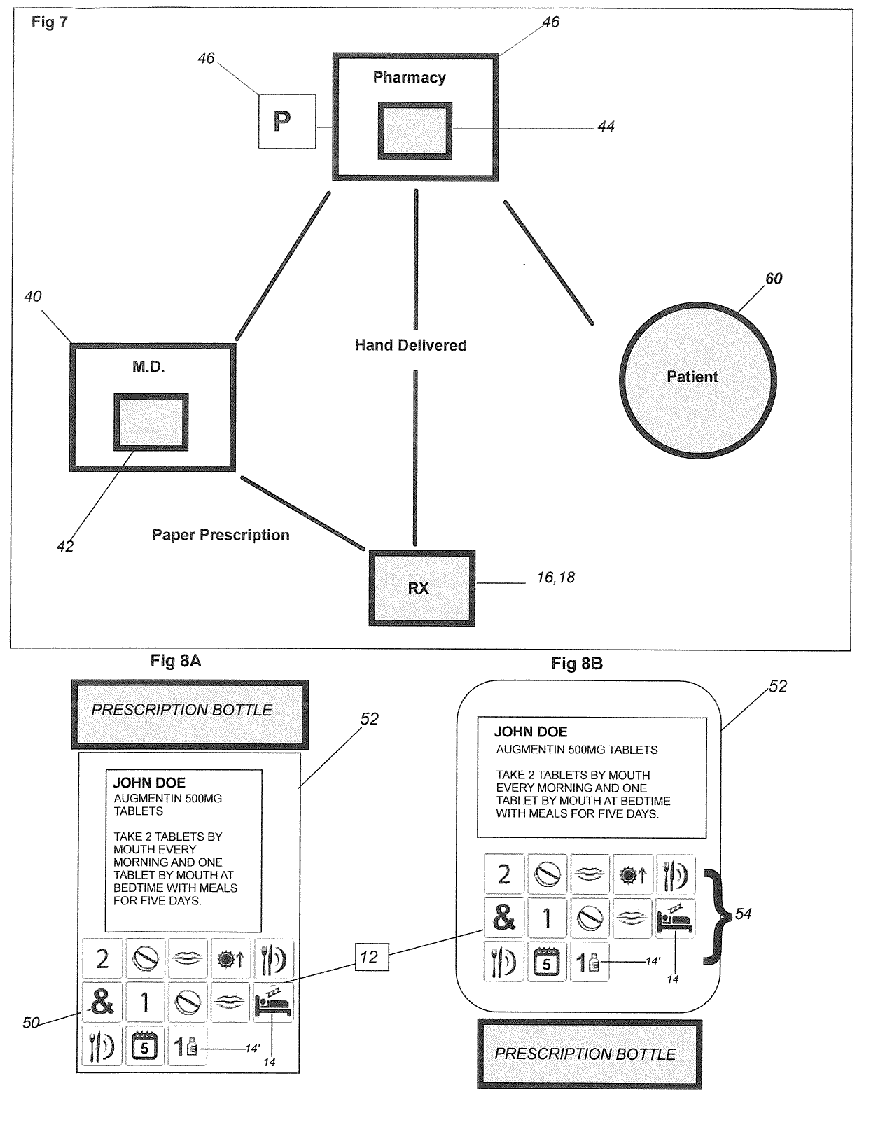

Further with regard to FIGS. 1-4, the medical office and pharmacy can include processors, prescription software and printers all appropriately structured to print out the labels and/or the indicators 12, 22, 24, 28, 30, etc. as described in greater detail in FIGS. 7, 8A and 8B.

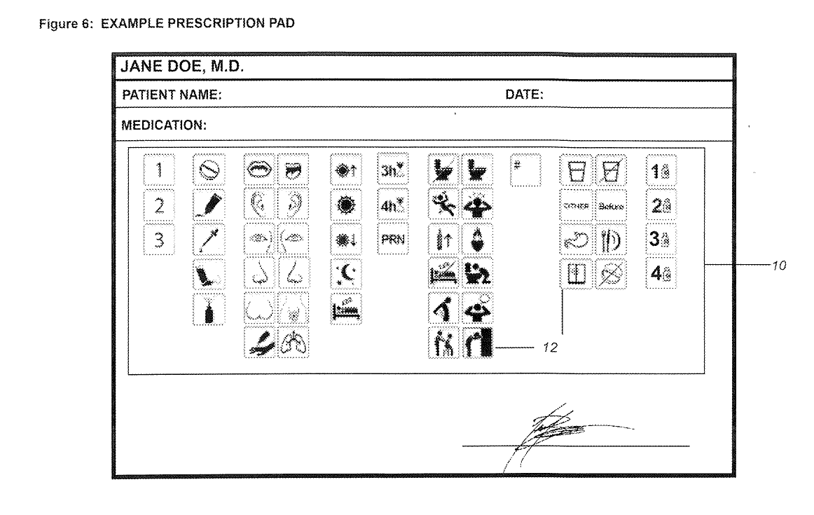

As represented in FIG. 6 an optional presentation structure may also be in the form of a printed or hard copy indicator composite 32 having the plurality of the indicators 10 arranged thereon. Therefore, in preparing the prescription form 16 and 18, a physician or other medical professional may select the appropriate indicators 12 from the indicator composite 32 and transfer the selected indicators 12 directly to the exposed face or surface of the prescription form 16, 18, etc. Therefore, in this embodiment each of the plurality of indicators 10 may have a connector, such as an adhesive backing, which facilitates the initial mounting of the plurality of indicators 12 of the indicator composite 32 but allows the removal or transfer directly to the outer surface of the presentation structure in the form of the prescription form 16, 18, etc.

Further with regard to the indicator composite 32 of FIG. 6, another way of “transferring” the selected indicators 12 to an appropriate presentation structure, such as a prescription form 16 and 18 or a label or outer surface of the container, may be by merely circling or otherwise physically indicating the selected ones of the indicators 12. The entire indicator composite 32 may then be presented to a pharmacist or other facility, wherein an array of plurality of selected indicators, such as 22 in FIG. 1 and 2 or 28, 30 in FIGS. 3 and 4, are created, printed or otherwise established by the pharmacist. The pharmacist is then arranges the selected indicators 22, 28, 30, etc. in a predetermined successive array, such that indicia 14 and 14′ may be successively presented and interpreted.

FIGS. 7, 8A and 8B represent yet another preferred embodiment which clearly emphasizes the versatility of the present invention. More specifically, as represented in FIG. 7 another preferred embodiment includes the use of electronic processor facilities. More specifically, a physician and/or an office of a medical professional 40 may include a processor 42 having appropriate storage facilities, database, electronic display screen, etc. As such, the plurality of indicators 10, as represented in FIG. 5 may take the form of an electronically displayed indicator composite 32 which may be stored on the processor 42. An appropriate “prescription software” or application may be operative on the processor 42, such that the physician may display an indicator composite such as, but not limited to, the composite 32 of FIG. 5 and electronically select, such as by a mouse or other appropriate interface, the pertinent plurality of indicators 12 having appropriate indicia 14 or 14′ which are representative of a specific prescription, as at 28 and 30 in FIGS. 3 and 4. Once selected, the predetermined indicators 12 are electronically transferred to a remote processor 44 associated with any one of a plurality of pharmacies or like facilities 46. The processor 44 may also incorporate an appropriate “prescription software” or application so as to display the indicators 28 or 30 selected buy the medical office 40 which is representative of a specific prescription. Once the selected the array of indicators 28 or 30 are received at remote processor 44, they may be printed by an appropriate printer 46 directly onto a label 50 or other hardcopy format. Once printed, the label 50 or other hardcopy or portions thereof may be transferred directly to an appropriate presentation structure such as on the exterior of a medicine container 52. Alternatively, the indicators 12 can be mechanically printed directly on a container 52. As yet another alternative, individual ones of the plurality of selected indicators 12, as at 28 or 30 are arranged in the predetermined, successive array collectively indicated as 54 in FIG. 8B, wherein such array is then placed directly on the exterior surface of a container 52′.

In the alternative, FIG. 7 also schematically represents the creation of a paper or hard copy prescription, such as the presentation structures in the form of prescription forms 16 and 18 to the patient. The patient may then hand deliver the prescription forms 16 and 18 directly to the pharmacist 46, wherein the predetermined array of indicators 12 having appropriate indicia 14 or 14′ are prepared, possibly using the processor 44 and printer 46 as set forth above. Thereafter, the selected indicia 28 or 30 are arranged successively in an appropriate array as at 50 and 54 and disposed on the exterior of a container 52 or 52′ for presentation to a patient as at 60.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system for implementing medical prescriptions at least partially independent of a written format, said system comprising:
a plurality of indicators each including indicia thereon, said indicia at least partially representative of the terms of the prescription,
at least some of said indicia comprising pictorial representations,
at least one presentation structure including selected ones of said plurality of indicators disposed thereon in a predetermined array, said one presentation structure indicative of at least intended use of the medical prescription, and
said indicia of said predetermined array of said selected indicators collectively defining the operative components of the prescription.

2. A system as recited in claim 1 wherein said predetermined array comprises said selected indicators being relatively disposed to define a predetermined, successive presentation of corresponding indicia.

3. A system as recited in claim 1 wherein said presentation structure comprises a prescription form.

4. A system as recited in claim 3 wherein said selected indicators are removably disposed on said prescription form.

5. A system as recited in claim 1 wherein said prescription structure comprises a label.

6. A system as recited in claim 5 wherein said selected indicators are removably disposed on said label.

7. A system as recited in claim 1 wherein said presentation structure comprises an outer surface of a container.

8. A system as recited in claim 7 wherein said selected indicators are removably disposed on said outer surface of said container.

9. A system as recited in claim 1 wherein said presentation structure comprises an electronic display of an electronic communication device.

10. A system as recited in claim 1 wherein at least some of said plurality of indicators include a connector, said connector structure for attachment of a corresponding indicator to said presentation structure.

11. A system as recited in claim 10 wherein at least some of said connectors comprise an adhesive structured to attach the corresponding indicator to said presentation structure.

12. A system as recited in claim 1 further comprising an indicator composite including at least some of said plurality of indicators, each of said plurality of indicators disposed on said composite in an independently selectable position relative to one another.

13. A system as recited in claim 12 wherein said plurality of indicators and said indicator composite are cooperatively structured for transfer of said selected indicators from said indicator composite to said presentation structure.

14. A system as recited in claim 13 wherein said indicator composite comprises an electronic display, said selected indicators electronically transferred to said presentation structure.

15. A system as recited in claim 14 wherein said presentation structure comprises an electronic display of a remote processor.

16. A system as recited in claim 13 wherein said indicator composite comprises a printed display.

17. A system as recited in claim 1 further comprising a processor including storage facilities and an electronic display, a prescription application operative on said processor for generating an indicator composite, said prescription application further operative to generate said predetermined array.

18. A system as recited in claim 17 wherein said processor is operative to electronically transfer said predetermined array to a remote processor at least partially defining a presentation structure.

19. A system as recited in claim 18 wherein said remote processor is structured to generate a hard copy of said predetermined array.

20. A method of implementing medical prescriptions at least partially independent of a written format, the method comprising:
accessing a plurality of indicators having indicia thereon, the indicia indicative of a plurality of terms defining the medical prescriptions,
defining at least some of the indicia to include pictorial representations,
selecting predetermined ones of the plurality of indicators having indicia collectively representative of terms of a specific predetermined prescription, and
disposing the selected indicators in a predetermined array comprising a successive presentation of the corresponding indicia of the selected indicators.

21. A method as recited in claim 20 comprising creating the predetermined array by accessing an indicator composite comprising the plurality of indicators.

22. A method as recited in claim 21 comprising defining the indicator composite as an electronic display of the plurality of indicators.

23. A method as recited in claim 22 comprising electronically transferring the predetermined array from the indicator composite to a remote presentation structure.

24. A method as recited in claim 23 further transferring the predetermined array from the remote presentation structure to a prescription container.

25. A method as recited in claim 20 comprising defining the indicator composite as a printed display.
